(19) United States
(12) Patent Application Publication
(10) Pub. No.: US 2013/0008151 A1
(43) Pub. Date: Jan. 10, 2013

(54) SYSTEMS AND METHODS FOR ROV MULTITASKING

(75) Inventors: Eric Joseph Munstereifel, Cypress, TX (US); John Douglas Hughes, Katy, TX (US)

(73) Assignee: BP CORPORATION NORTH AMERICA INC., Houston, TX (US)

(21) Appl. No.: 13/454,621

(22) Filed: Apr. 24, 2012

Related U.S. Application Data
(60) Provisional application No. 61/479,246, filed on Apr. 26, 2011.

(51) Int. Cl. F15B 13/02

(52) U.S. Cl. 60/325

(57) ABSTRACT

A remotely operated vehicle system comprises a primary hydraulic system and a multitask interface panel including a hydraulic receptacle in selective fluid communication with the primary hydraulic system. The multitask interface panel is configured for selective connection and disconnection to one or more hydraulically powered devices while the multitask interface panel is subsea.

### CROSS-REFERENCE TO RELATED APPLICATIONS

This application claims benefit of U.S. provisional patent application Ser. No. 61/479,246 filed Apr. 26, 2011, and entitled “Systems and Methods for ROV Multitasking,” which is hereby incorporated herein by reference in its entirety.

### STATEMENT REGARDING FEDERALLY SPONSORED RESEARCH OR DEVELOPMENT

Not applicable.

### BACKGROUND

1. Field of the Invention

This disclosure relates generally to systems and methods for connecting multiple hydraulically powered devices to a remotely operated vehicle (ROV). More specifically, this disclosure relates to systems and methods for connecting hydraulically powered devices to a primary hydraulic system of a subsea ROV.

2. Background of the Technology

In offshore hydrocarbon drilling and production operations, ROVs can be used to deploy, inspect, operate, and/or recover subsea equipment. Many conventional ROVs are equipped with multiple independent hydraulic systems each hydraulic system being completely isolated from the others. In such cases, a primary hydraulic system is typically associated with primary ROV functions such as powering thrusters to produce ROV movement and/or powering primary manipulators. The thrusters, primary manipulators, and other essential hydraulically powered devices are hard plumbed to the primary hydraulic system in a dry environment (i.e., while the ROV is out of the water) to prevent the ingress of water into the primary hydraulic system. The need to limit the ingress of water into the hydraulic system also requires tripping the ROV to the surface to add, remove, or swap out hydraulically powered devices. Tripping to the surface and subsequent reworking of hard plumbing to change a hydraulically powered device can be time consuming and especially costly when performing subsea tasks for which time is of the essence.

In some cases, multiple ROVs are employed to collectively perform subsea tasks using a variety of different hydraulically powered tools and devices. The ROVs, however, may not all be configured to interface with each of the various hydraulically powered tools/devices that are on site. This inability for all ROVs to interface with each of the hydraulically powered devices can create logistical difficulties and inefficiencies.

Accordingly, there remains a need in the art for improved systems and methods that allow for the connection of additional hydraulically powered devices to the primary hydraulic system of an ROV. Such systems and methods would be particularly well-received if they enabled the subsea connection of hydraulically powered devices to the ROV hydraulic system (i.e., without the need to trip the ROV to the surface) and enhanced the interchangeability of hydraulically powered devices between ROVs having different connection interfaces.

### BRIEF SUMMARY OF THE DISCLOSURE

These and other needs in the art are addressed in one embodiment by a remotely operated vehicle system. In an embodiment, the system includes a primary hydraulic system. In addition, the system includes a multitask interface panel including a hydraulic receptacle in selective fluid communication with the primary hydraulic system. The multitask interface panel is configured for selective connection and disconnection to one or more hydraulically powered devices while the multitask interface panel is subsea.

These and other needs in the art are addressed in another embodiment by a multitask interface panel for connection to a primary hydraulic system of a remotely operated vehicle. In an embodiment, the multitask interface panel includes a hydraulic hot stab receptacle configured to selectively receive hydraulic fluid of the primary hydraulic system into a control path of the hydraulic hot stab receptacle.

These and other needs in the art are addressed in another embodiment by a collaborative remotely operated vehicle system. In an embodiment, the system includes a first remotely operated vehicle comprising a first connection interface configured for connecting a hydraulic system of the first remotely operated vehicle to a first hydraulically powered device. In addition, the system includes a second remotely operated vehicle comprising a second connection interface that is different from the first connection interface and that is configured for connecting a hydraulic system of the second remotely operated vehicle to a second hydraulically powered device. Further, the system includes a first multitask interface panel connected to the first connection interface, the first multitask interface panel being configured to connect between the first connection interface and to a third hydraulically powered device. Still further, the system includes a second multitask interface panel connected to the second connection interface, the second multitask interface panel being configured to connect between the second connection interface and to the third hydraulically powered device.

Thus, embodiments described herein include a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of this disclosure, reference will now be made to the accompanying drawings in which:

FIG. 1 is a schematic view of an embodiment of an ROV system in accordance with the principles described herein;

FIG. 2 is a schematic view of an embodiment of a collaborative ROV system in accordance with the principles described herein;

FIG. 3 is an oblique front view of an embodiment of a multitask interface panel in accordance with the principles described herein; and

FIG. 4 is an oblique rear view of the multitask interface panel of FIG. 3.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct engagement of the two devices, or through an indirect connection via other intermediate devices, components, and connections. In addition, as used herein, the terms “axial” and “axially” generally mean along or parallel to a given axis (e.g., central axis of a body or a port), while the terms “radial” and “radially” generally mean perpendicular to the axis. For instance, an axial distance refers to a distance measured along or parallel to the axis, and a radial distance means a distance measured perpendicular to the axis.

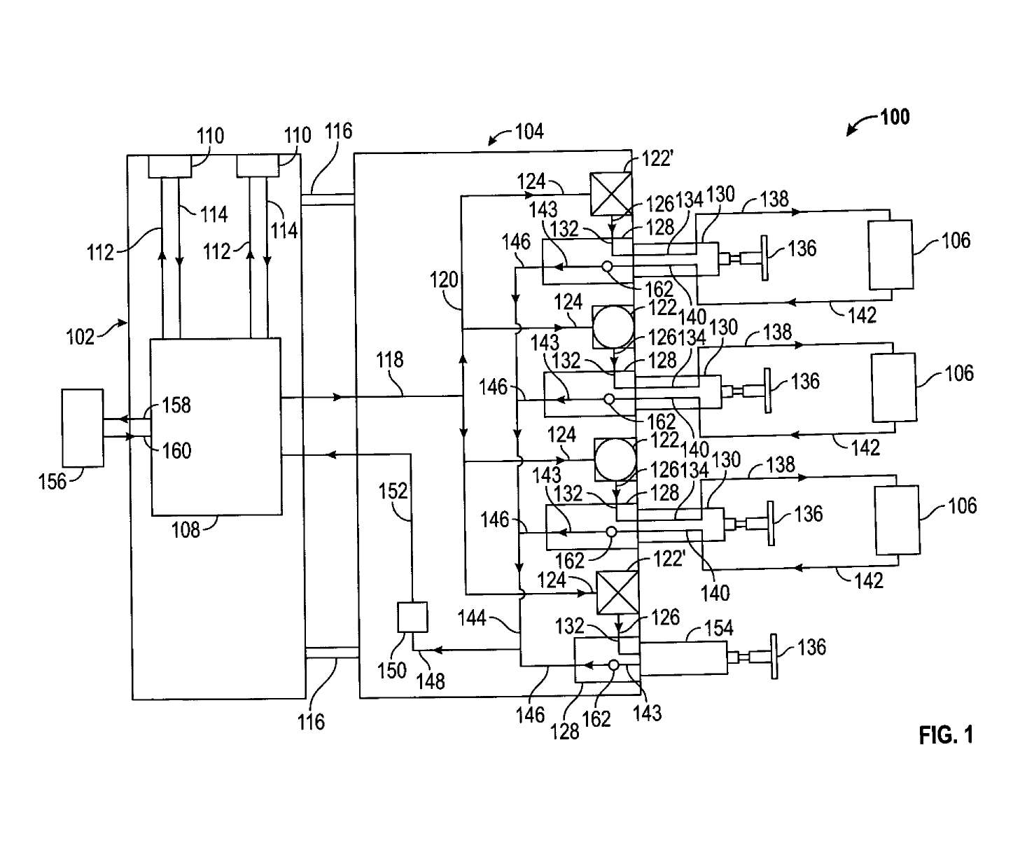

Referring now to FIG. 1, a simplified schematic view of an ROV system 100 for performing subsea operations is shown. The ROV system 100 includes an ROV 102, a multitask interface panel (MIP) 104, and a plurality of hydraulically powered devices (HPDs) 106. In general, HPDs 106 may comprise any hydraulically powered devices known in the art including, without limitation, Class 4 or Class 5 rotary torque tools, linear override tools, guillotine hydraulic cutters, hydraulic impact wrenches, hydraulic rotary saws, other rotary or linear tooling driven with hydraulic fluids, or combinations thereof. The ROV 102 includes a primary hydraulic system 108 to selectively power thrusters 110 via hard plumbed thruster hydraulic supply lines 112 and thruster hydraulic return lines 114. In general, the primary hydraulic system 108 can be configured to pump any suitable fluid including, without limitation, mineral oil, corrosion inhibitors, methanol, water glycol, and/or other suitable hydraulic control fluids. In this embodiment, the primary hydraulic system 108 is configured to pump mineral oil. The ROV 102 is securely attached to the MIP 104, for example, via bolts 116 and/or other structural components.

A hydraulic supply interconnect 118 joins the primary hydraulic system 108 with a hydraulic supply header 120 of the MIP 104. A plurality of valves 122 are connected to the supply header 120 via valve supply lines 124. In general, valves 122 can be manually operated and/or electronically controlled to selectively allow hydraulic fluid to flow therethrough at various rates of flow. In this embodiment, valves 122 are manually operated ball valves that are actuated and transitioned between open and closed positions by manipulator 156 of ROV 102. In FIG. 1, valves 122 that are fully closed are designated with reference numeral 122′ and are depicted with an “X” mark, while valves 122 that are fully open remain designated with reference numeral 122 and are depicted with an “0” mark.

Valve exit lines 126 connect valves 122, 122′ to mating receptacles 128 that selectively receive complementary plugs 130. Each receptacle 128 includes control fluid paths 132 that selectively join in fluid communication with control fluid paths 134 of plugs 130. The mating receptacles 128 and plugs 130 can be any suitable quick-connect couplings, such as a “hot-stab” connection, that allow subsea connection and subsea disconnection therebetween. In this embodiment, the receptacles 128 and plugs 130 are API 17-H compliant devices. More specifically, in this embodiment, the receptacles 128 and plugs 130 are so-called dual port hot stab connectors that provide two independent hydraulic fluid flow paths within the wall of the receptacle 128. In other embodiments, the receptacles 128 and plugs 130 can be ISO 13628-8 compliant and/or compliant with any other suitable standard compatible with subsea implementations. The receptacles 128 and plugs 130 can optionally include integrated check valves or other fluid control devices to control fluid flow therethrough. Handles 136 are provided on plugs 130 for manipulating and positioning the plugs 130 during insertion and/or removal of the plugs 130 from mating receptacles 128. In this embodiment, handles 136 are T-handles configured to be securely grasped by manipulator 156 of ROV 102.

The control fluid paths 134 of plugs 130 are connected to HPDs 106 via control lines 138 that supply hydraulic fluid to the HPDs 106. The HPDs 106 are also connected to return fluid paths 140 of the plugs 130 via return lines 142. The return lines 142 return hydraulic fluid that exits the HPDs 106 to the associated plugs 130. The return fluid paths 140 of plugs 130 are connected to return fluid paths 143 of receptacles 128 in the same manner as the connection between the control paths 132 of the receptacles 128 and the control paths 134 of the plugs 130.

Referring still to FIG. 1, the return fluid paths 143 of receptacles 128 are connected to a return header 144 via receptacle return lines 146. A filter feed line 148 connects the return header 144 to a filter 150. In this embodiment, the filter 150 is configured to allow passage of mineral oil hydraulic fluid while water and/or other contaminants are segregated from the hydraulic fluid and prevented from exiting the filter 150. In general, the filter 150 may be any filter known in the art that allows passage of mineral oil hydraulic fluid while limiting and/or preventing water and other contaminants from passing therethrough including, without limitation, water absorbing cellulose type filters such as the CJC™ filter elements available from C.C.Jensen A/S of Denmark. A return interconnect 152 joins the filter 150 to the primary hydraulic system 108 so that the MIP 104 generally includes a hydraulic fluid circuit between the supply interconnect 118 and the return interconnect 152. The MIP 104 is depicted as including a dummy plug 154 configured to selectively be received by receptacles 128. The dummy plug 154 blocks and seals control fluid path 132 and the return fluid path 143 instead of facilitating a fluid circuit between the control fluid path 132 and the return fluid path 143. In this embodiment, the dummy plug 154 also includes a handle 136 that can be configured as a T-handle or any other suitable handle design for reliable handling by manipulator 156 of ROV 102.

The ROV 102 further includes primary manipulator 156 that is supplied hydraulic fluid from the primary hydraulic system 108 via a hydraulic manipulator supply 158. Hydraulic fluid can be returned to the primary hydraulic system 108 from the primary manipulator 156 via a hydraulic manipulator return 160. The primary manipulator 156 is selectively controlled to grasp, manipulate, and/or otherwise move subsea objects, including components of the ROV system 100.

In this embodiment, the ROV system 100 is assembled at the surface, and then deployed subsea. The thrusters 110 are powered by the primary hydraulic system 108 to propel the ROV system 100 to a selected subsea location and/or depth. While submerged, the components of the MIP 104 can be exposed to the local fluid sea pressure and operate successfully while maintaining a fluid tight barrier between the above-described fluid circuit between the supply interconnect 118 and the return interconnect 152. In operation of the ROV system 100, the primary hydraulic system 108 supplies hydraulic fluid to the supply interconnect 118. Because the valves 122 are in an open position, the hydraulic fluid can flow from the supply interconnect 118 to the valves 122 via the valve supply lines 124 associated with the open valves 122; and because the valves 122′ are in a closed position, fluid cannot flow through the closed valves 122′. Hydraulic fluid flows through the open valves 122 and thereafter to associated receptacles 128 via valve exit lines 126. The hydraulic fluid then flows from valve exit lines 126 successively into and through the associated control paths 132 of the receptacles 128, control paths 134 of the plugs 130, and control lines 138. The hydraulic fluid exiting the control lines 138 powers the HPDs 106. Accordingly, the embodiment shown in FIG. 1 enables a plurality of HPDs 106 to be powered by a primary hydraulic system 108 through the use of the MIP 104. Still further, because the valves 122, 122′ can be selectively controlled to various positions (i.e., open or closed), the ROV system 100 can be operated to selectively provide a hydraulic fluid flow to one or more HPDs 106 in a subsea environment. The positions of the valves 122, 122′ can be controlled using the manipulator 156 of ROV 102, a manipulator of a different ROV, and/or can be electronically, mechanically, pneumatically, and/or hydraulically controlled using any other suitable device or system.

The hydraulic fluid that exits the HPDs 106 after powering the HPDs 106 can successively flow to and through the associated return lines 142, return fluid paths 143 of the receptacles 128, the receptacle return lines 146, and the return header 144. Hydraulic fluid can flow from the return header 144 to the filter 150 via the filter feed line 148. The filter 150 preferably removes water and other contaminates entrained in or otherwise flowing with the hydraulic fluid. In this embodiment, the filter 150 segregates water from mineral oil hydraulic fluid and retains the segregated water within the filter 150. Filtered hydraulic fluid flows from the filter 150 back to the primary hydraulic system 108 via the return interconnect 152. Although referred to herein for convenience as a “filter,” filter 150 can be a separator or other device capable of segregating differing liquids (e.g. water from hydraulic fluid). Accordingly, the ROV system 100 can selectively power HPDs 106 with a primary hydraulic system 108 of an ROV 102 while also cleaning the hydraulic fluid of the primary hydraulic system 108. In some embodiments, an additional valve 122 can be provided along with suitably configured hydraulic lines to provide a bypass circuit that allows the MIP 104 to serve as an auxiliary hydraulic fluid filtration system even when all valves 122 associated with providing hydraulic fluid to HPDs 106 are closed.

Unlike most conventional ROV hydraulic systems, any HPD 106 can be removed from the ROV system 100 while the ROV system 100 is subsea. In particular, while the ROV system 100 is located subsea, a valve 122 associated with the HPD 106 to be removed is actuated to a closed position. After closure, the valve 122′ no longer allows hydraulic fluid to pressurize the control fluid path 132 of the corresponding receptacle 128. Next, the primary manipulator 156 and/or any other manipulator is used to grasp the handle 136 associated with the plug 130 attached to the HPD 106 to be removed. The primary manipulator 156 then applies sufficient force to the handle 136 to dislodge the plug 130 from the receptacle 128, and thereafter slides the plug 130 fully out of the receptacle 128. With the plug 130 separated from the receptacle 128, the primary manipulator 156 places the removed plug 130 and associated removed HPD 106 in a location away from the ROV system 100. In some embodiments, the receptacles 128 can include biased valves 162 disposed along the return fluid paths 143 and configured to automatically actuate to isolate a portion of the return fluid paths 143 from water in response to the above-described dislodging of a plug 130. To further prevent ingress of water and/or other contaminants, the dummy plug 154 can be inserted into the empty receptacle 128. In this manner, the hydraulic fluid is protected from significant ingress of water. As described above, in the event water and/or contaminants enter into the return header 144, the water and/or contaminants eventually flow to the filter 150 where they are removed from the hydraulic fluid. Accordingly, this embodiment of an ROV system 100 is particularly suited for removing an HPD 106 from the ROV system 100 without exposing the primary hydraulic system 108 that powers the HPD 106 to a substantial risk of water and/or contaminant ingress. In the manner described, this embodiment enables the removal of an HPD 106 from an ROV system 100 while the ROV system 100 is located subsea without allowing significant amounts of water and/or contaminants to reach the primary hydraulic system 108.

An HPD 106 can also be added to the ROV system 100 while the ROV system 100 is subsea or otherwise submerged in water. Such an example is best explained with reference to FIG. 1. In particular, while the ROV system 100 is located subsea, a valve 122′ associated with an HPD 106 to be added is actuated to a closed position. After closure, the valve 122′ no longer allows hydraulic fluid to pressurize the control fluid path 132 of the associated receptacle 128. Next, the primary manipulator 156 (and/or any other manipulator 156) is used to grasp the handle 136 of a dummy plug 154 in the receptacle 128 that is to receive an HPD 106. The primary manipulator 156 applies sufficient force to the handle 136 to dislodge the dummy plug 154 from the receptacle 128 and thereafter slide the dummy plug 154 fully out of the receptacle 128. With the dummy plug 154 and the receptacle 128 fully separated from each other, the primary manipulator 156 stows the removed dummy plug 154 in a location away from the ROV system 100. In this exemplary embodiment, the receptacles 128 include biased valves 162 disposed along the return fluid paths 143 and configured to automatically actuate to isolate a portion of the return fluid paths 143 from water in response to the above-described dislodging of the dummy plug 154. In this manner, the hydraulic fluid is prevented from significant ingress of water. Next, the primary manipulator 156 grasps the handle 136 of a plug 130 associated with an HPD 106 to be added to the ROV system 100. The primary manipulator also inserts the plug 130 into the receptacle 128. Upon sufficient forcing of the plug 130 into the receptacle 128, the plug 130 and the receptacle 128 form fluid tight seals that permit passage of hydraulic fluid there between while simultaneously preventing egress of hydraulic fluid from the receptacle 128 and the plug 130 and ingress of substantial amounts of water into the hydraulic fluid. In the event water and/or contaminants enter into the return header 144, the water and/or contaminants eventually flow to the filter 150 where they are removed from the hydraulic fluid. Accordingly, this embodiment of an ROV system 100 is particularly suited for adding an HPD 106 to the ROV system 100 without exposing the primary hydraulic system 108 that powers the HPD 106 to a risk of water and/or contaminant ingress. In the manner described, this embodiment enables an HPD 106 to be added to an ROV system 100 while the ROV system 100 is located subsea and without allowing significant amounts of water and/or contaminants to ingress and reach the primary hydraulic system 108.

The ROV system 100 thus described is particularly suited for selective and simultaneous hydraulic powering of multiple HPDs 106. As shown in FIG. 1, the two HPDs 106 associated with the open valves 122 are operated simultaneously in response to the application of hydraulic pressure from the primary hydraulic system 108. The open valves 122 can be operated to selectively and independently increase or decrease hydraulic power supplied to the two HPDs 106. In some embodiments, the number of potential HPDs 106 to be powered by a single primary hydraulic system 108 can be increased by connecting an additional MIP 104 to a receptacle 128 of the MIP 104 hard plumbed to the primary hydraulic system 108. Accordingly, this disclosure provides systems and methods for, while an ROV system 100 is subsea, increasing the number of HPDs 106 powered by ROV system 100 via daisy chain connections between additionally provided MIPs 104. In other words, while the ROV system 100 was originally configured to power a first number of HPDs 106 when deployed subsea, the above-described daisy chaining of MIPs 104 can significantly increase the number of HPDs 106 that can be powered by the single primary hydraulic system 108 of an ROV system 100.

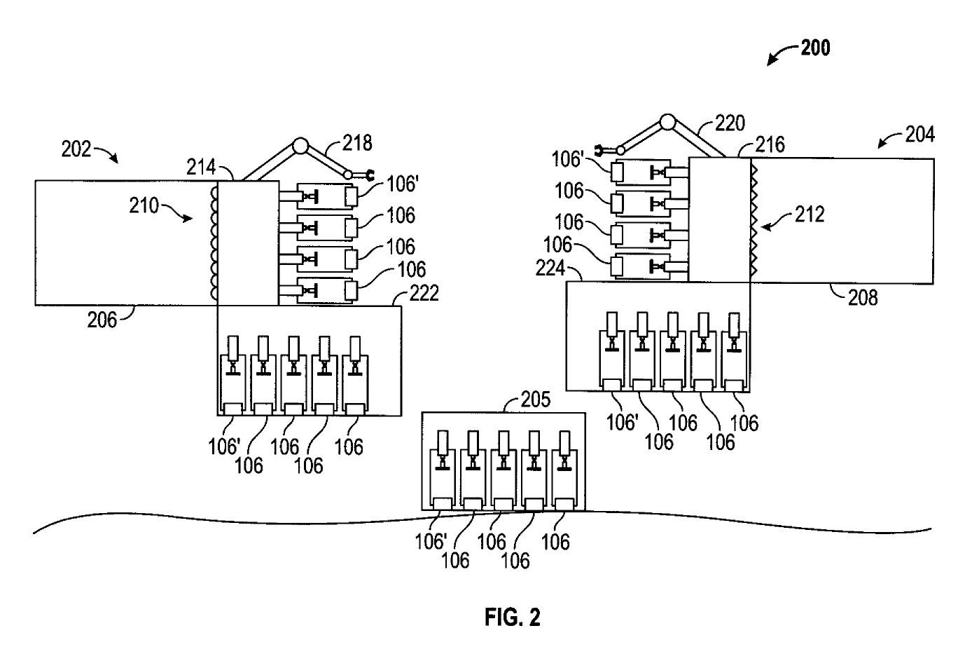

Referring now to FIG. 2, a collaborative ROV system 200 is shown. The collaborative ROV system 200 includes a first ROV system 202, a second ROV system 204, and a subsea basket 205, which can be any suitable container, skid, or other device for transporting and containing equipment and tools. The ROV systems 202, 204 are each substantially the same as the ROV system 100 previously described, with the exception that ROVs 206, 208 of ROV systems 202, 204, respectively, have native HPD 106 connection interface types 210, 212 that differ from one another. In some cases, the differences in the connection interface types 210, 212 can be attributable to the ROVs 206, 208 being manufactured by different companies and/or because the ROVs 206, 208 are different models. Accordingly, MIPs 214, 216 are installed to the different connection interface types 210, 212, respectively, so that each ROV system 202, 204 is thereafter equally capable of connecting to and disconnecting from MIPs 214, 216 that are substantially similar and/or identical to the MIP 104 previously described.

Because each ROV system 202, 204 includes a substantially similar and/or identical MIP 214, 216, any HPD 106 configured for selective connection to the MIP 214 can be connected to the substantially similar MIP 216. Accordingly, any HPD 106 provided with a configuration suitable for connecting to either one of the MIPs 214, 216 will generally also be suitable for connecting to the other one of the MIPs 214, 216. In this embodiment of the collaborative ROV system 200, enhanced equipment redundancy can be achieved by providing multiple ones of a particular type of HPD 106, those HPDs 106 being operable by either of the ROVs 206, 208, regardless of the manufacturer, model, and/or native HPD 106 format of the ROVs 206, 208. In this embodiment, each of the ROVs 206, 208 include a primary manipulator 218, 220, respectively, that is substantially similar and/or identical to the primary manipulator 156 previously described. ROV systems 202, 204 further include ROV baskets 222, 224, respectively.

In operation of the collaborative ROV system 200, first ROV system 202 is deployed subsea and/or otherwise submerged in water. The first ROV system 202 can initially be connected to a first type of HPD 106′ that is crucial to a subsea operation to be carried out by the collaborative ROV system 200. However, should the first type HPD 106′ of the first ROV system 202 fail, the subsea operation can be continued in one of many ways. Because the second ROV system 204 includes a first type of HPD 106′, the second ROV system 204 can perform the operation instead of the first ROV system 202. However, in some cases, the second ROV system 204 may be performing other important tasks and/or may not be able to participate in performing the operation. In such cases, the ROV system 202 can employ use of the primary manipulator 218 to disconnect the first type HPD 106′ from the MIP 214. After removing the failed HPD 106′, the primary manipulator 220 can retrieve a replacement from any of baskets 205, 222, 224 and install the replacement HPD 106′ to the MIP 214 without requiring a trip to the surface of the water. Alternatively, the primary manipulator 218 or the primary manipulator 220 can be used to remove a first type HPD 106′ and install the first type HPD 106′ to the MIP 214. In this embodiment, the removal and installation of HPDs 106 includes following substantially similar installation and removal techniques and/or steps as the above-described connection and disconnection of receptacles 128 and complementary plugs 130 with the attached HPDs 106.

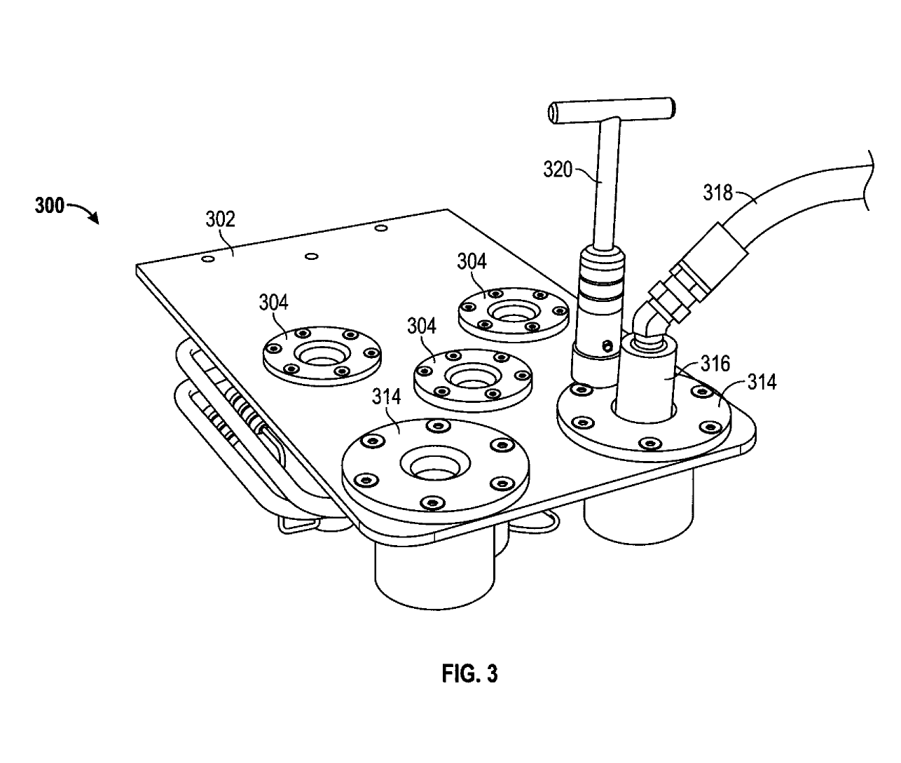

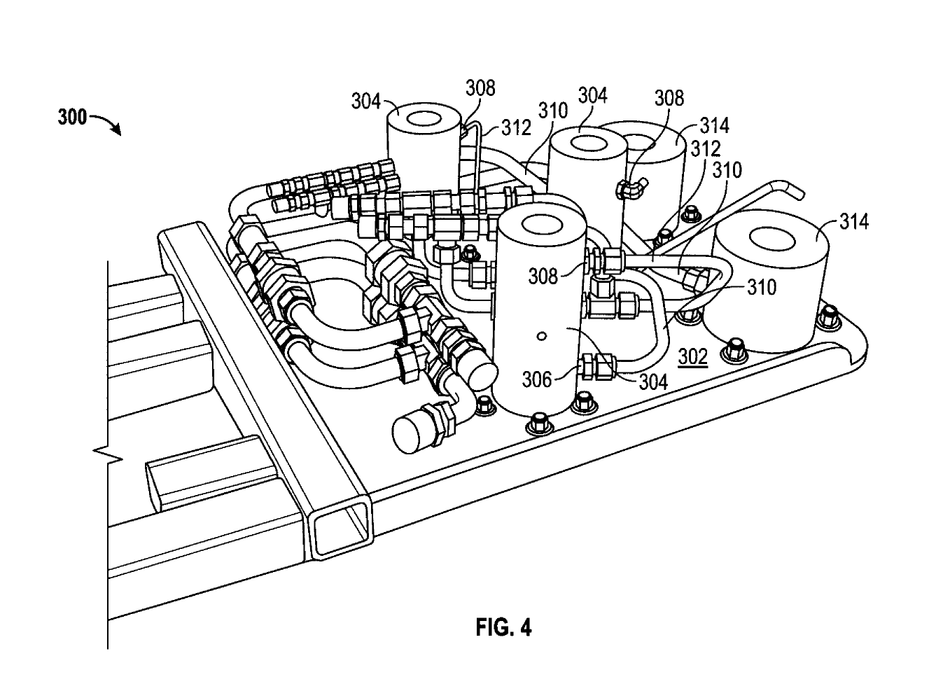

Referring now to FIGS. 3 and 4, an embodiment of a partially assembled MIP 300 is shown. In FIG. 3 an oblique front view of the MIP 300 is shown, while in FIG. 4, an oblique rear view of the MIP 300. The MIP 300 includes a mounting plate 302 to which the remainder of the components of the MIP 300 are secured. In this embodiment, the MIP 300 includes three dual port hot stab receptacles 304. Each hot stab receptacle 304 includes a control port 306 and a return port 308. Each control port 306 is shown as being hard plumbed to a control line 310 that can be connected to a supply header. Each return port 308 is shown as being hard plumbed to a return line 312 that can be connected to a return header. The MIP 300 further includes two single port hot stab receptacles 314. One single port hot stab receptacle 314 is connected to control line 310 for connection to the supply header while the other single port hot stab receptacle is hard plumbed to a return line 312 for connection to a return header. A single port hot stab plug 316 is shown as being received by one of the single port hot stab receptacles 314 and the hot stab plug 316 is connected to a hydraulic hose 318. The hot stab plug 316 includes a handle 320. In this embodiment, handle 320 is a T-handle.

As compared to conventional ROV systems, the ROV systems disclosed herein provide the ability to connect and disconnect hydraulically powered devices while the ROV systems are subsea and without a need to resurface. Further, the ROV systems disclosed herein provide increased equipment redundancy relative to sharing hydraulically powered devices even while using ROVs of different brands and/or models. Still further, the ROV systems disclosed herein allow use of ROV primary hydraulic systems for add-on hydraulically powered devices without harming the hydraulic fluid and/or components of the primary hydraulic systems.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A remotely operated vehicle system, comprising:
a primary hydraulic system; and
a multitask interface panel comprising a hydraulic receptacle in selective fluid communication with the primary hydraulic system, the multitask interface panel being configured for selective connection and disconnection to one or more hydraulically powered devices while the multitask interface panel is subsea.

2. The remotely operated vehicle system of claim 1, further comprising:
a valve connected between the primary hydraulic system and the hydraulic receptacle and configured to selectively allow a flow of hydraulic fluid between the hydraulic system and the hydraulic receptacle.

3. The remotely operated vehicle system of claim 1, further comprising:
a filter connected between the primary hydraulic system and the hydraulic receptacle, the filter being configured to segregate water from hydraulic fluid of the primary hydraulic system.

4. The remotely operated vehicle system of claim 1, wherein the hydraulic receptacle is compliant with an API 17-H standard and the hydraulic receptacle is configured to selectively receive a hot stab plug also compliant with the API 17-H standard.

5. The remotely operated vehicle system of claim 1, wherein the hydraulic receptacle comprises at least two isolated flow paths extending through a wall of the hydraulic receptacle, one of the flow paths being configured to supply hydraulic fluid to the hydraulically powered device connected to the hydraulic receptacle and the other flow path being configured to receive hydraulic fluid from the hydraulically powered device.

6. The remotely operated vehicle system of claim 5, further comprising:
a plurality of the hydraulic receptacles;
wherein each of the hydraulic receptacles is connected to a hydraulic fluid supply header to receive a hydraulic fluid from the hydraulic system; and
wherein each of the hydraulic receptacles is connected to a hydraulic fluid return header to return the hydraulic fluid to the hydraulic system.

7. A multitask interface panel for connection to a primary hydraulic system of a remotely operated vehicle, the multitask interface panel comprising:
a hydraulic hot stab receptacle configured to selectively receive hydraulic fluid of the primary hydraulic system into a control path of the hydraulic hot stab receptacle.

8. The multitask interface panel of claim 7, wherein the hydraulic hot stab receptacle is compliant with an API 17-H standard.

9. The multitask interface panel of claim 7, further comprising a valve disposed between the control path of the hydraulic hot stab receptacle and the primary hydraulic system and wherein the valve is selectively operable to control hydraulic fluid flow from the primary hydraulic system to the hydraulic hot stab receptacle.

10. The multitask interface panel of claim 9, wherein the valve is configured for actuation by a manipulator of the remotely operated vehicle.

11. The multitask interface panel of claim 10, wherein the valve is a ball valve.

12. The multitask interface panel of claim 7, wherein the multitask interface panel is configured for operation in subsea environmental conditions.

13. The multitask interface panel of claim 7, further comprising:
a filter disposed between a return path of the hydraulic hot stab receptacle and the primary hydraulic system and wherein the filter is configured to segregate water from hydraulic fluid.

14. The multitask interface panel of claim 7, wherein the hydraulic hot stab receptacle comprises a biased valve configured to prevent ingress of fluid into a return path of the hydraulic hot stab receptacle.

15. A collaborative remotely operated vehicle system, comprising:
a first remotely operated vehicle comprising a first connection interface configured for connecting a hydraulic system of the first remotely operated vehicle to a first hydraulically powered device;
a second remotely operated vehicle comprising a second connection interface that is different from the first connection interface and that is configured for connecting a hydraulic system of the second remotely operated vehicle to a second hydraulically powered device;
a first multitask interface panel connected to the first connection interface, the first multitask interface panel being configured to connect between the first connection interface and to a third hydraulically powered device; and
a second multitask interface panel connected to the second connection interface, the second multitask interface panel being configured to connect between the second connection interface and to the third hydraulically powered device.

16. The collaborative remotely operated vehicle system of claim 15, wherein an interface of the first multitask interface panel available for connection to the third hydraulically powered device is substantially similar to an interface of the second multitask interface panel available for connection to the third hydraulically powered device.

17. The collaborative remotely operated vehicle system of claim 16, wherein the first multitask interface panel and the second multitask interface panel each comprise at least one hydraulic hot stab receptacle for use in connecting the first multitask interface panel and the second multitask interface panel to the third hydraulically powered device.

18. The collaborative remotely operated vehicle system of claim 17, wherein at least one of the first multitask interface panel and the second multitask interface panel comprises a filter configured to segregate water from hydraulic fluid.

19. The collaborative remotely operated vehicle system of claim 17, wherein at least one of the first remotely operated vehicle and the second remotely operated vehicle comprises a basket configured to carry a plurality of hydraulically powered devices.

20. The collaborative remotely operated vehicle system of claim 19, wherein at least one of the first remotely operated vehicle and the second remotely operated vehicle comprises a manipulator configured to selectively connect the third hydraulically powered device to at least one of the first multitask interface panel and the second multitask interface panel, the connection being made subsea.
